(19) United States
(12) Patent Application Publication
(10) Pub. No.: US 2020/0160292 A1
(43) Pub. Date: May 21, 2020

(54) VIRTUAL CURRENCY PAYMENT PROXY DEVICE, VIRTUAL CURRENCY PAYMENT PROXY METHOD, AND RECORDING MEDIUM

(71) Applicant: NEC CORPORATION, Tokyo (JP)

(72) Inventor: Sanami NAKAGAWA, Tokyo (JP)

(73) Assignee: NEC CORPORATION, Tokyo (JP)

(21) Appl. No.: 16/631,919

(22) PCT Filed: Jul. 21, 2017
(86) PCT No.: PCT/JP2017/026521

§ 371 Date: Jan. 17, 2020

(51) Int. Cl. G06Q 20/08; G06Q 40/04; G06Q 20/06

(52) U.S. Cl. CPC G06Q 20/0855; G06Q 20/065; G06Q 40/04

(57) ABSTRACT

The present invention enables payment proxy for a virtual currency in a decentralized virtual currency system. A payment proxy device includes: first generation unit for generating a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency; acquisition unit for acquiring payment destination identification information transmitted by a payment destination as an evidence of receipt of money and intended for identifying the payment destination; and second generation unit for generating a second transaction using the first transaction as a balance, and a fourth transaction using, as a balance, a third transaction generated by the payment source.

### TECHNICAL FIELD

The present invention relates to a virtual currency payment proxy device and so on.

### BACKGROUND ART

Bitcoin (see NPL 1) is a decentralized virtual currency which enables data on a virtual currency to be shared distributedly. Moreover, there is a blockchain technique as a technique with which a large number of users manage a virtual currency by broadcasting data to one another. A virtual currency utilizing a blockchain technique records transfer of value from a payment source to a payment destination. Techniques related to a virtual currency are disclosed in, for example, PTLs 1 and 2.

A user account (hereinafter also simply referred to as an “account”) is normally required for utilization of such a virtual currency. In order to acquire an account and manage a virtual currency, a user is required to use an electronic instrument such as a personal computer (PC) or a smartphone. Note that a technique related to payment proxy in a (non-virtual currency) electronic payment system is disclosed in, for example, PTL 3.

### CITATION LIST

### Patent Literature

[PTL 1] Japanese Unexamined Patent Application Publication No. 2016-170530
[PTL 2] Japanese Unexamined Patent Application Publication No. 2013-531855
[PTL 3] Japanese Unexamined Patent Application Publication No. 2006-260277

### Non Patent Literature

[NPL 1] Satoshi Nakamoto, “Bitcoin: A Peer-to-Peer Electronic Cash System”, [online], [retrieved on Nov. 7, 2016], Internet <URL: https://bitcoin.org/bitcoin.pdf>

### SUMMARY OF INVENTION

### Technical Problem

Even in a decentralized virtual currency, a demand for payment proxy by a proxy can be assumed. For example, there is a need to, when paying money to a user having no account, enable a virtual currency to be utilized for payment without bothering the user who receives the money to acquire an account. For example, for a person who is not used to handling an electronic instrument, such a troublesome procedure as acquisition of an account can lead to a situation where utilization of a virtual currency is prevented. Moreover, when an account is acquired, a trouble of managing a virtual currency is also caused later.

However, the existing virtual currency systems as disclosed PTLs 1 and 2 and NPL 1 do not enable payment proxy in a decentralized virtual currency. Moreover, payment proxy in such an electronic payment system as disclosed in PTL 3 which is different from a virtual currency is not applicable to a decentralized virtual currency system as it is.

An exemplary object of the present invention is to provide a technique intended for enabling payment proxy of a virtual currency in a decentralized virtual currency system.

### Solution to Problem

According to one aspect of the present invention, a payment proxy device of a virtual currency includes: first generation means for generating a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency; acquisition means for acquiring payment destination identification information transmitted by a payment destination as an evidence of receipt of money and intended for identifying the payment destination; and second generation means for generating a second transaction using the first transaction as a balance, and a fourth transaction using, as a balance, a third transaction generated by the payment source, wherein the second generation means generates the second transaction including, as approval information of the payment destination, the payment destination identification information acquired from the payment destination represented by the payment destination information included in the destinations of the first transaction in order to use the first transaction as a balance, and including the approval information of the proxy, and second destination information including the account of the proxy as a destination, and in order to use, as a balance, the third transaction including third destination information which includes, as destinations, the account of the proxy and the account of the payment source, and the approval information of the payment source, generates the fourth transaction including the approval information of the payment source received from the payment source after acquisition of the payment destination identification information, the approval information of the proxy, and fourth destination information including the account of the proxy as a destination.

According to another aspect of the present invention, a payment proxy method of a virtual currency includes: generating a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency; acquiring payment destination identification information transmitted by a payment destination as an evidence of receipt of money and intended for identifying the payment destination; generating a second transaction by use of the first transaction as a balance, the second transaction including, as approval information of the payment destination, the payment destination identification information acquired from the payment destination represented by the payment destination information included in the destinations of the first transaction, and including second destination information which includes the approval information of the proxy and the account of the proxy as a destination; and by use of, as a balance, a third transaction generated by the payment source, and including third destination information which includes, as destinations, the account of the proxy and the account of the payment source, and the approval information of the payment source, generating a fourth transaction including the approval information of the payment source received from the payment source after acquisition of the payment destination identification information, the approval information of the proxy, and fourth destination information including the account of the proxy as a destination.

According to another aspect of the present invention, a computer-readable non-transitory recording medium records a program which causes a computer to execute: processing of generating a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency; processing of acquiring payment destination identification information transmitted by a payment destination as an evidence of receipt of money and intended for identifying the payment destination; and processing of generating a second transaction using the first transaction as a balance, and a fourth transaction using, as a balance, a third transaction generated by the payment source, wherein the second transaction includes, as approval information of the payment destination, the payment destination identification information acquired from the payment destination represented by the payment destination information included in the destinations of the first transaction in order to use the first transaction as a balance, and includes the approval information of the proxy, and second destination information including the account of the proxy as a destination, and the fourth transaction includes, in order to use, as a balance, the third transaction including third destination information which includes, as destinations, the account of the proxy and the account of the payment source, and the approval information of the payment source, the approval information of the payment source received from the payment source after acquisition of the payment destination identification information, the approval information of the proxy, and fourth destination information including the account of the proxy as a destination.

### Advantageous Effects of Invention

The present invention enables payment proxy of a virtual currency in a decentralized virtual currency system.

### BRIEF DESCRIPTION OF DRAWINGS

FIG. 1 is a block diagram illustrating one example of a configuration of a payment proxy device.

FIG. 2 is a sequence chart illustrating one example of a procedure of payment proxy.

FIG. 3 is a block diagram illustrating another example of a configuration of a payment proxy device.

FIG. 4 is a flowchart illustrating one example of an operation of the payment proxy device.

FIG. 5 is a block diagram illustrating one example of a configuration of a payment proxy system.

FIG. 6 is a block diagram illustrating still another example of a configuration of a payment proxy device.

FIG. 7 is a sequence chart illustrating one example of an operation during trading of a virtual currency.

FIG. 8 is a sequence chart illustrating another example of an operation during trading of a virtual currency.

FIG. 9 is a block diagram illustrating one example of a hardware configuration of a computer device.

### EXAMPLE EMBODIMENT

### First Example Embodiment

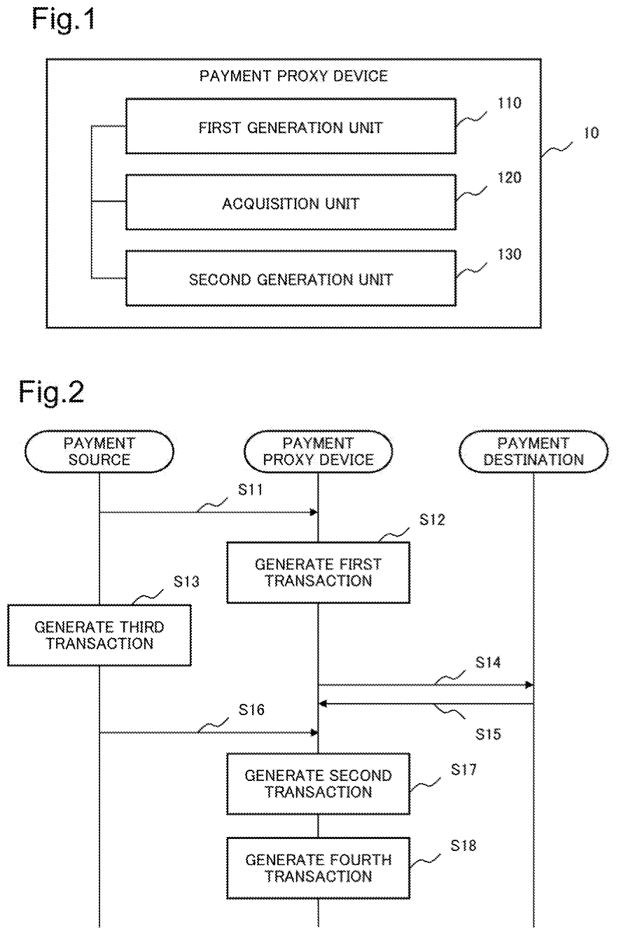

FIG. 1 is a block diagram illustrating a configuration of a payment proxy device 10 according to one example embodiment. The payment proxy device 10 is a computer device applied to a decentralized virtual currency system. The payment proxy device 10 includes at least a first generation unit 110, an acquisition unit 120, and a second generation unit 130. The payment proxy device 10 may include another component as required.

Herein, a decentralized virtual currency system refers to a virtual currency system which does not require a certain organization (central organization). For example, a virtual currency system called bitcoin is one example of a decentralized virtual currency system referred to herein. However, the payment proxy device 10 is not limited to the bitcoin, and is applicable to payment proxy for all virtual currencies using a blockchain technique. Note that, unless otherwise stated, a term “virtual currency system” described below means a decentralized virtual currency system using a blockchain technique.

The payment proxy device 10 enables trading of a virtual currency between a user (hereinafter also referred to as a “payment source [payer]”) having an account of a virtual currency system, and another user (hereinafter also referred to as a “payment destination [payee]”) having no account of the virtual currency system. The present example embodiment enables such trading via a proxy operating the payment proxy device 10. Note that a payment source may be reworded as a payer. In addition, a payment destination may be reworded as a payee. Moreover, a payment source, a payment destination, and a proxy are not limited to natural persons, and may be legal persons.

The first generation unit 110 generates a first transaction. Herein, a transaction refers to data representing trading of a virtual currency, i.e., movement of a monetary value. More specifically, a transaction includes at least destination information and approval information. A transaction may include other information. A transaction may include, for example, amount information. Herein, amount information is information indicating a quantity of a monetary value, and indicates, for example, an amount by a predetermined monetary unit being utilizable in a virtual currency system. Note that a virtual currency may be represented by a unit which is unique to a virtual currency system, and may also be represented by being converted into a currency (legal currency) guaranteed by a nation or the like, such as the Japanese yen or the U.S. dollar.

Destination information indicates a destination of a virtual currency. Destination information is configured in such a way as to be able to include a plurality of users as destinations. A user is identified by, for example, an account. An account is data allocated in order to uniquely specify a user, such as a so-called user identifier (ID). An account is allocated to a user at utilization of a virtual currency system (e.g., during registration). Moreover, a user may be identified by information being equivalent to an account and uniquely specifying a user. Information being equivalent to an account and uniquely specifying a user will be described later. A user who has become a destination of a transaction requires approval information of the user being the destination, in order to utilize a virtual currency relevant to the transaction.

Approval information is information for guaranteeing validity of a transaction. Approval information is information associated with an account. Approval information is, for example, electronic signature data allocated to an individual user of a virtual currency system. Note that an electronic signature referred to herein is not necessarily limited to a specific scheme.

Furthermore, approval information may be information associated with information other than an account included in destination information. Note that information associated with information other than an account will be described later.

The first generation unit 110 generates a first transaction in response to a request from a payment source. The first transaction includes first destination information including, as destinations, an account of a proxy, an account of a payment source, and payment destination information representing a payment destination, and approval information of the proxy. The first transaction represents at least movement of an amount to be paid to a payment destination from a payment source. Note that the first transaction may represent, as required, movement of an amount including required expense (a charge relating to recording of a transaction and proxy thereof, or the like). Moreover, the first destination information includes, herein, accounts of two users and approval information of one person, but may include accounts of three or more persons. For example, the first destination information may include accounts of a plurality of proxies.

The payment destination information is information representing a destination to which a payment source pays money. The payment destination information is information being equivalent to an account and uniquely specifying a payment destination. The payment destination information indicates a destination approved by payment destination identification information described later. When the payment destination identification information is an electronic signature generated by use of a signing key generated by a payment destination, the payment destination identification information may be generated based on a verification key of the electronic signature of the payment destination.

The first transaction is a transaction functioning as a so-called deposit (guaranty money). That the first destination information includes a plurality of users as destinations means that it is not possible to utilize a virtual currency unless there are a predetermined number of a plurality of pieces of approval information relevant to the plurality of users. In the present example embodiment, the first transaction is a transaction using a function of a multi-signature (also referred to as “multisig”), and includes a plurality of users as destinations. The first transaction becomes utilizable by approval information of a proxy, and approval information of a payment source and/or approval information of a payment destination (described later). The first transaction is generated by use of a balance. The first transaction is generated, for example, by use of an unused virtual currency of a proxy.

The acquisition unit 120 acquires payment destination identification information transmitted by a payment destination as an evidence of receipt of money and intended for identifying the payment destination. The payment destination identification information is information proving that money paid to a payment destination from a proxy is received by the payment destination. The payment destination identification information is transmitted from the payment destination to the proxy. The payment destination identification information is information being information other than an account and being associated with payment destination information. The payment destination identification information may be, for example, an electronic signature generated by use of a signing key generated by a payment destination, or may be other information. The payment destination identification information is information for guaranteeing validity of a transaction including destination identification information in a destination, and is information equivalent to approval information associated with an account.

The second generation unit 130 generates a second transaction by use of, as a balance, a first transaction generated by the first generation unit 110 and recorded in a blockchain.

The second transaction includes, as approval information of a payment destination, payment destination identification information acquired from the payment destination represented by payment destination information included in a destination of a first transaction in order to use the first transaction as a balance. Further, the second transaction includes approval information of a proxy, and second destination information including an account of the proxy as a destination. The second transaction indicates movement of an amount determined based on an amount represented by a first transaction. The second transaction may include amount information. Movement of an amount of which movement is indicated by a second transaction is the same as an amount of which movement is indicated by a first transaction. Note that the second transaction may include approval information of a payment source.

A first transaction and a second transaction are different in the following points. Firstly, the first transaction includes, in a destination, an account of a payment source and payment destination information representing a payment destination, whereas the second transaction does not include, in a destination, an account of a payment source and payment destination information. Secondly, the first transaction does not include approval information of a payment destination, whereas the second transaction includes approval information of a payment destination.

Information which is not included in the first transaction and is included in the second transaction is approval information of a payment destination. The second generation unit 130 can generate a second transaction by using, as approval information of a payment destination, payment destination identification information transmitted from the payment destination. When receiving money from a proxy, the payment destination transmits payment destination identification information as an evidence of receipt of the money. Thereafter, when the acquisition unit 120 receives the payment destination identification information, the second transaction generated by the second generation unit 130 is registered in a blockchain in a way similar to the first transaction.

Furthermore, the second generation unit 130 generates a fourth transaction by use of, as a balance, a third transaction generated by a payment source and recorded in a blockchain.

The fourth transaction generated by the second generation unit 130 uses, as a balance, the third transaction generated by a payment source. The third transaction indicates movement of an amount to be paid to a proxy from a payment source. The third transaction includes third destination information including, as destinations, an account of a proxy and an account of a payment source, and approval information of the payment source. The third transaction may include amount information. An amount of which movement is indicated by the third transaction has only to be at least an amount to be paid to a payment destination from a payment source. Note that the third transaction may represent, as required, movement of an amount including required expense (a charge relating to recording of a transaction and proxy thereof, or the like). The third transaction generated by the payment source is registered in a blockchain in a way similar to the first transaction.

The second generation unit 130 generates a fourth transaction after confirming that the third transaction is registered in the blockchain. Note that the second generation unit 130 may generate a fourth transaction after generating a second transaction, or may generate a fourth transaction before generating a second transaction. Moreover, the second generation unit 130 may simultaneously generate a second transaction and a fourth transaction.

In order to generate a fourth transaction which uses a third transaction as a balance, the second generation unit 130 receives, from a payment source, approval information of the payment source relevant to an account of a payment source included in a destination of the third transaction. The second generation unit 130 receives, from a payment source, approval information of the payment source, for example, after the acquisition unit 120 receives payment destination identification information.

The fourth transaction generates a fourth transaction including approval information of a payment source received from the payment source, approval information of a proxy, and fourth destination information including an account of the proxy as a destination. The fourth transaction indicates movement of an amount determined based on an amount represented by a third transaction. The fourth transaction may include amount information. Movement of an amount of which movement is indicated by a fourth transaction is the same as an amount of which movement is indicated by a third transaction.

A third transaction and a fourth transaction are different in the following points. Firstly, the third transaction includes an account of a payment source in a destination, whereas the fourth transaction does not include an account of a payment source in a destination. Secondly, the third transaction does not include approval information of a proxy, whereas the fourth transaction includes approval information of a proxy.

Information which is not included in the third transaction and is included in the fourth transaction is approval information of a proxy. The second generation unit 130 can generate a fourth transaction using, as a balance, the third transaction including approval information of a proxy as a destination, by using approval information of a payment source received from the payment source, and own (proxy) approval information. The fourth transaction generated by the second generation unit 130 is registered in a blockchain in a way similar to the first transaction.

A configuration of the payment proxy device 10 is as above. By operating in the following way under such a configuration, the payment proxy device 10 enables payment proxy of a virtual currency by a proxy.

FIG. 2 is a sequence chart illustrating a procedure of payment proxy using the payment proxy device 10. In step S11, a payment source provides required information to the payment proxy device 10. Herein, information required for payment proxy includes at least an account of a payment source, information for specifying a payment destination, and information indicating an amount to be paid to the payment destination. Information for specifying a payment destination may be, for example, an identifier indicating a payment destination associated with payment destination information, may be a mail address, or may be other information (a name or appellation of a payment destination, or the like). Moreover, information for specifying a payment destination may be payment destination information.

A method of providing the information by a payment source is not limited to a specific method. For example, a payment source may transmit required information to the payment proxy device 10 by use of an electronic instrument such as a smartphone. Alternatively, a payment source may visit a store operated by a proxy, and convey required information in writing or orally, or may mail a proxy a document describing required information.

For convenience of description, a providing action by a payment source in step S11 is hereinafter referred to as a “request”. It can be said that a request referred to herein is also an expression of an intention of payment from a payment source to a payment destination via the payment proxy device 10.

At provision, i.e., a request of such information, the payment proxy device 10 executes step S12. In step S12, the first generation unit 110 generates, based on information provided from the payment source, a first transaction indicating movement of an amount (trading of a virtual currency) to be paid to a payment destination. As described above, the first transaction includes first destination information including, as destinations, an account of a proxy, an account of a payment source, and payment destination information representing a payment destination, and approval information of the proxy. An account of a payment source and payment destination information representing a payment destination are specified based on information provided from a payment source. On the other hand, an account and approval information of a proxy are previously recorded in the payment proxy device 10, or are acquirable from a predetermined storage device.

The first transaction generated in step S12 is registered in a blockchain. For example, the first transaction is registered in a blockchain by a miner of a virtual currency. A first transaction registered in a blockchain is configured in such a way that it is not possible to utilize the first transaction without approvals of a proxy and at least another user among destinations included in first destination information, i.e., an approval of a proxy, and an approval of a payment source and/or a payment destination.

A payment source executes step S13. A payment source which executes step S13 is, for example, an electronic instrument such as a smartphone utilized by the payment source. The payment source may execute step S13 after confirming that a first transaction is registered in a blockchain. In step S13, the payment source generates a third transaction indicating at least trading of a virtual currency for an amount to be paid to a payment destination. As described above, the third transaction includes third destination information including, as destinations, an account of a proxy and an account of a payment source, and approval information of the payment source. An account and approval information of a payment source are previously recorded in a terminal device utilized by the payment source, or are acquirable from a predetermined storage device. The third transaction is registered in a blockchain in a way similar to the first transaction. A third transaction registered in a blockchain is configured in such a way that it is not possible to utilize the third transaction without approvals of a destination (i.e., a proxy and a payment source) included in third destination information.

Thereafter, in step S14, a proxy executes, for a payment destination, payment of an amount specified by information indicating an amount to be paid to the payment destination, included in information required for payment proxy. Although FIG. 2 describes in such a way that the payment proxy device 10 makes payment to the payment destination, the payment proxy device 10 is not required to utilize a virtual currency. The payment proxy device 10 or a proxy managing the payment proxy device 10 transfers, for example, cash equivalent to an amount to be paid to a payment destination, to an account of the payment destination opened in a financial institution such as a bank. Alternatively, a proxy may make payment with cash or a credit card in a store operated by a payment destination. Moreover, a proxy may make payment with a virtual currency different from a virtual currency used for payment proxy.

After a proxy or the payment proxy device 10 used by the proxy makes payment to a payment destination, the payment destination transmits payment destination identification information to the payment proxy device 10 in step S15. A method of transmitting payment destination identification information by a payment destination is not limited to a specific method. For example, a payment destination may transmit payment destination identification information to the payment proxy device 10 by use of an electronic instrument such as a smartphone. Alternatively, a payment destination may transmit payment destination identification information to another device different from the payment proxy device 10. In this case, the another device transfers the payment destination identification information to the payment proxy device 10.

Note that payment destination identification information transmitted to the payment proxy device 10 by a payment destination may be secret information generated by use of a secret key generated by the payment destination, may be an electronic signature given to information indicating that a payment destination has received money, or may be another form. Payment destination identification information has only to approve a transaction related to payment destination information, and the transaction including the payment destination information in a destination.

In step S16, a payment source transmits approval information of a payment source to the payment proxy device 10. The payment source may transmit approval information of the payment source from the payment proxy device 10, in response to a notification indicating that the acquisition unit 120 has acquired payment destination identification information.

Then, the payment proxy device 10 executes step S17. Note that the payment proxy device 10 may execute step S17 before step S16, or may execute step S17 simultaneously with step S16. In step S17, the second generation unit 130 generates a second transaction by use of, as a balance, the first transaction generated in step S12 and registered in a blockchain. Herein, the second generation unit 130 generates a second transaction including payment destination identification information as approval information of the payment destination, and including approval information of a proxy. The second generation unit 130 has approval information for approving a plurality of destinations included in a first transaction. Thus, the second generation unit 130 can generate a second transaction by use of the first transaction as a balance.

The second transaction is registered in a blockchain in a way similar to the first transaction. A proxy can utilize the second transaction as a balance. In other words, a proxy can apply a virtual currency of an amount indicated by the second transaction to a virtual currency that can be utilized by the proxy.

Furthermore, the payment proxy device 10 executes step S18. In step S18, the second generation unit 130 generates a fourth transaction by use of, as a balance, the third transaction generated in step S13 and registered in a blockchain. Herein, the second generation unit 130 generates a second transaction including approval information of a proxy, and the approval information of a payment source received in step S16. The second generation unit 130 has approval information for approving a plurality of destinations included in a third transaction. Thus, the second generation unit 130 can generate a fourth transaction by use of the third transaction as a balance.

The fourth transaction is registered in a blockchain in a way similar to the first transaction. A proxy can utilize the fourth transaction as a balance. In other words, a proxy can apply a virtual currency of an amount indicated by the fourth transaction to a virtual currency that can be utilized by the proxy.

As described above, the payment proxy device 10 according to the present example embodiment has a configuration which generates a first transaction including, as destinations, an account of a proxy, an account of a payment source, and payment destination information representing a payment destination, and generates a second transaction using the first transaction as a balance. Moreover, the payment proxy device 10 has a configuration which generates a third transaction generated by a payment source and including, as destinations, an account of a proxy and an account of a payment source, and generates a fourth transaction using the third transaction as a balance. An account of a payment destination is not required at generation of the transactions. Therefore, even when a payment destination does not create an account or the like, a payment source can utilize a virtual currency for payment to the payment destination. Thus, by such a configuration, the payment proxy device 10 according to the present example embodiment can achieve payment proxy of a virtual currency in a decentralized virtual currency system.

Furthermore, in the present example embodiment, a proxy is not able to freely utilize, solely by an own intention, a deposited virtual currency and a virtual currency from a payment source, at a point where a first transaction is generated, and at a point where a third transaction is generated, respectively, and becomes able to utilize the virtual currencies at points where a second transaction and a fourth transaction are generated. By generating a transaction stepwise in this way, the payment proxy device 10 according to the present example embodiment can achieve payment proxy of a virtual currency, and can also prevent unauthorized utilization (e.g., utilization of a virtual currency by a proxy before the proxy completes payment to a payment destination).

### Second Example Embodiment

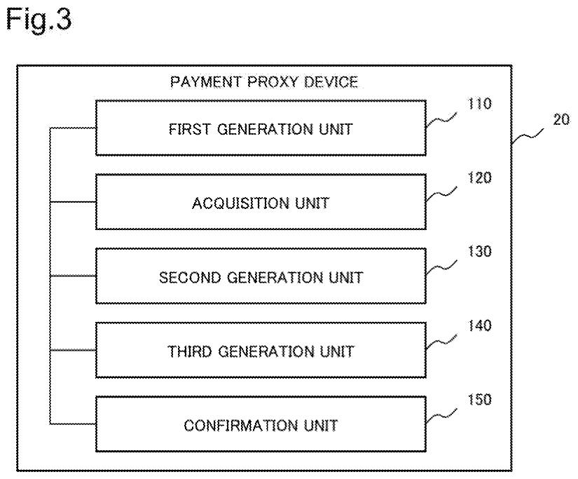

FIG. 3 is a block diagram illustrating a configuration of a payment proxy device 20 according to another example embodiment. The payment proxy device 20 includes the same configuration as the payment proxy device 10 according to the first example embodiment. Specifically, the payment proxy device 20 includes a first generation unit 110, an acquisition unit 120, a second generation unit 130, a third generation unit 140, and a confirmation unit 150.

Among terms used in the following example embodiments and modification examples, a term that is also used in the first example embodiment is used in the same meaning as the term used in the first example embodiment, unless otherwise noted. Moreover, in the present example embodiment, a component which is given the same reference sign as that of a component described in the first example embodiment is a component similar to the component having the same reference sign described in the first example embodiment. Thus, repeated description relating to such a component may be appropriately omitted.

The first generation unit 110 generates a first transaction similar to that of the payment proxy device 10 according to the first example embodiment. Moreover, the acquisition unit 120 acquires payment destination identification information from a payment destination, in a way similar to the payment proxy device 10 according to the first example embodiment. Further, the second generation unit 130 generates a second transaction similar to that of the payment proxy device 10 according to the first example embodiment.

The third generation unit 140 generates a fifth transaction and a sixth transaction which are different from any of the first transaction, the second transaction, a third transaction, and a fourth transaction. The third generation unit 140 generates the fifth transaction by use of, as a balance, the first transaction generated by the first generation unit 110 and recorded in a blockchain. The fifth transaction is the same as the second transaction in using the first transaction as a balance. Moreover, the third generation unit 140 generates the sixth transaction by use of, as a balance, the third transaction generated by a payment source and recorded in a blockchain. The sixth transaction is the same as the fourth transaction in using the third transaction as a balance.

The third generation unit 140 selectively operates with the second generation unit 130. More specifically, the second generation unit 130 operates when the acquisition unit 120 receives payment destination identification information, i.e., when money is paid to a payment destination by a proxy and the payment destination receives the money, whereas the third generation unit 140 operates when a virtual currency is paid (i.e., paid back) to generation sources of the first transaction and the third transaction. For example, when a payment is not made by a proxy (a payment destination does not receive money), the third generation unit 140 generates the fifth transaction, and offsets the first transaction being a deposit. Moreover, when a payment is not made by a proxy, the third generation unit 140 pays back money to a payment source by generating the sixth transaction for paying back the third transaction generated by the payment source as a transaction for a payment.

The fifth transaction includes fifth destination information including an account of a proxy as a destination, approval information of the proxy, and approval information of a payment source. A difference between the fifth transaction and the second transaction is that the second transaction includes, as approval information of a payment destination, payment destination identification information transmitted from the payment destination, whereas the fifth transaction includes approval information of a payment source. As described above, the first transaction registered in a blockchain is configured in such a way that it is not possible to utilize the first transaction without approvals of a proxy and at least another user among destinations included in first destination information, i.e., an approval of a proxy, and an approval of a payment source and/or a payment destination. The third generation unit 140 generates the fifth transaction including approval information of a proxy and approval information of a payment source, in order to use the first transaction as a balance. Note that an amount of which movement is indicated by the fifth transaction is the same as an amount of which movement is indicated by the first transaction. Moreover, the fifth transaction may include amount information.

The sixth transaction includes sixth destination information including an account of a payment source as a destination, approval information of a proxy, and approval information of the payment source. A difference between the sixth transaction and the fourth transaction is that the fourth transaction includes an account of a proxy as a destination, whereas the sixth transaction includes an account of a payment source as a destination. As described above, the third transaction registered in a blockchain is configured in such a way that it is not possible to utilize the third transaction without an approval of a destination (i.e., a proxy and a payment source) included in third destination information. The third generation unit 140 generates the sixth transaction including approval information of a proxy and approval information of a payment source, in order to use the third transaction as a balance. Note that an amount of which movement is indicated by the sixth transaction is the same as an amount of which movement is indicated by the third transaction. Moreover, the sixth transaction may include amount information.

The confirmation unit 150 confirms receipt of money by a payment destination. The confirmation unit 150 confirms receipt of the money by the payment destination, by confirming whether or not the acquisition unit 120 has acquired payment destination identification information, within a predetermined period after the first transaction and the third transaction are registered in a blockchain.

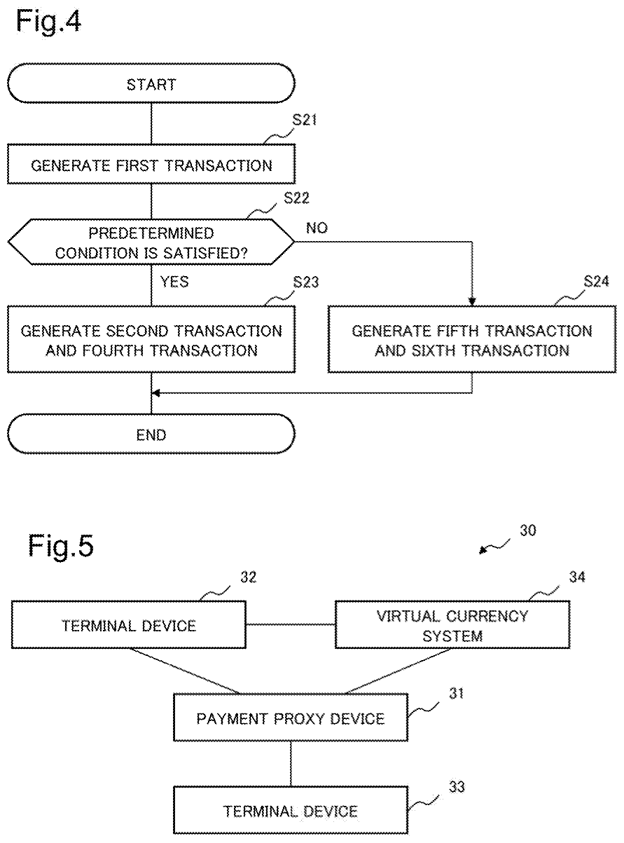

FIG. 4 is a flowchart illustrating an operation of the payment proxy device 20. Note that, at the operation, a payment source and a payment destination can perform actions similar to those in the first example embodiment. In other words, prior to generation of the first transaction, a payment source executes a request similar to that in step S11. Moreover, the payment source generates the third transaction after generation of the first transaction.

In step S21, the first generation unit 110 generates a first transaction. At a request from a payment source, the first generation unit 110 generates a first transaction. Note that information included in the first transaction is similar to that in the first example embodiment.

In step S22, the confirmation unit 150 determines whether a predetermined condition relating to receipt is satisfied. A condition referred to herein is that, for example, “a payment destination receives a predetermined charge from a proxy”, i.e., the acquisition unit 120 acquires payment destination identification information. When the condition relating to receipt includes a time limit, the confirmation unit 150 suspends determination until the time limit arrives.

When the condition relating to receipt is satisfied (S22:YES), the second generation unit 130 executes step S23. On the other hand, when a condition relating to payment is not satisfied (S22:NO), the third generation unit 140 executes step S24. In step S23, the second generation unit 130 generates a second transaction and a fourth transaction. In step S24, the third generation unit 140 generates a fifth transaction and a sixth transaction.

As described above, the payment proxy device 20 according to the present example embodiment has a configuration which selectively generates a second transaction and a fourth transaction or a fifth transaction and a sixth transaction, according to a determination result by the confirmation unit 150. The configuration enables changing of a destination or approval information of a transaction, depending on presence or absence of receipt of money by a payment destination. Specifically, the payment proxy device 20 generates a second transaction and a fourth transaction designating a proxy as a destination when a payment destination receives money, and the payment proxy device 20 generates a fifth transaction designating a proxy as a destination and a sixth transaction designating a payment source as a destination when a payment destination does not receive money. Thus, in addition to an effect similar to that of the payment proxy device 10 according to the first example embodiment, the payment proxy device 20 according to the present example embodiment can pay back a virtual currency to a proxy and a payment source when a payment destination does not receive money, i.e., when payment proxy of money is not properly performed.

### Third Example Embodiment

FIG. 5 is a block diagram illustrating a configuration of a payment proxy system 30 according to still another example embodiment. The payment proxy system 30 includes a payment proxy device 31, a terminal device 32, a terminal device 33, and a virtual currency system 34.

The payment proxy device 31 is a computer device which achieves proxy of trading by a proxy. The payment proxy device 31 is equivalent to one example of the payment proxy device 10 according to the first example embodiment or the payment proxy device 20 according to the second example embodiment.

The terminal device 32 is a terminal device used by a user of a payment source. On the other hand, the terminal device 33 is a terminal device used by a user of a payment destination. Although each of the terminal device 32 and the terminal device 33 is an electronic instrument such as a smartphone, a specific configuration thereof is not limited as long as exchange of required data with the payment proxy device 31 is possible.

The virtual currency system 34 is a decentralized virtual currency system, and is a peer-to-pear (P2P) type payment system of a virtual currency. In other words, the virtual currency system 34 is configured by a plurality of nodes of a peer-to-pear type network. A virtual currency in the present example embodiment is bitcoin based on PTL 1. In other words, the virtual currency system 34 manages a virtual currency by using a blockchain technique.

Note that, generally, the term “bitcoin” indicates a specific virtual currency in one case, and indicates a virtual currency system using the virtual currency in another case. In the present example embodiment, in order to avoid confusion, the term “bitcoin” is used with the meaning of a virtual currency. Moreover, a currency unit of bitcoin is “BTC”.

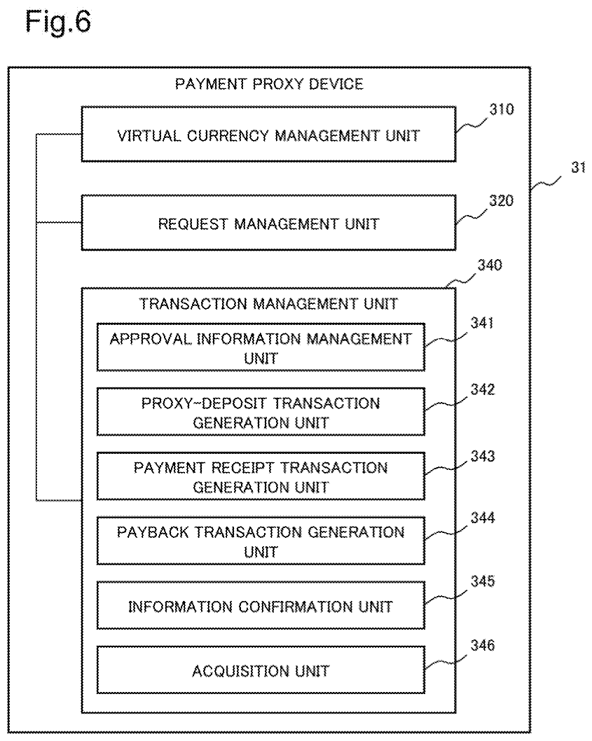

FIG. 6 is a block diagram illustrating a configuration of the payment proxy device 31. The payment proxy device 31 includes a virtual currency management unit 310, a request management unit 320, and a transaction management unit 340. More specifically, the transaction management unit 340 includes an approval information management unit 341, a proxy-deposit transaction generation unit 342, a payment receipt transaction generation unit 343, a payback transaction generation unit 344, an information confirmation unit 345, and an acquisition unit 346.

The virtual currency management unit 310 manages a virtual currency owned by the payment proxy device 31. The virtual currency management unit 310 manages an account of a proxy, and a balance of a virtual currency of the proxy. The virtual currency management unit 310 records, in a predetermined recording medium, the account of the proxy and the balance of the virtual currency of the proxy, and reads the account and the balance as required. Note that the virtual currency management unit 310 may acquire a balance of a virtual currency of a proxy from the virtual currency system 34, instead of storing the balance in the payment proxy device 31.

The request management unit 320 manages a request, i.e., a request for payment proxy by a virtual currency from a payment source. The request management unit 320 receives the request from the terminal device 32. A request in the present example embodiment means data including a bitcoin address for specifying a payment source, information for specifying a payment destination, and payment information indicating a payment amount to be paid to the payment destination via a proxy. Note that a bitcoin address is generated based on a verification key of an electronic signature of a user. A bitcoin address is equivalent to one example of an “account” in the first and second example embodiments. Moreover, payment information can include an expense such as a transaction charge, in addition to an amount to be paid to a payment destination.

Information for specifying a payment destination is equivalent to one example of “payment destination information” in the first and second example embodiments. The payment destination information is, for example, open information generated based on a verification key of an electronic signature generated by a payment destination. Note that information for specifying a payment destination may be an identifier indicating a payment destination associated with payment destination information, may be a mail address, or may be other information (a name or appellation of a payment destination, or the like). In this case, payment destination information associated with information for specifying a payment destination received by the payment proxy device 31 has only to be acquired from a recording unit or the like storing the payment destination information. When information for specifying a payment destination included in the received request is not information being describable in a destination of a transaction, the request management unit 320 may convert the information for specifying a payment destination into a form being describable as a destination of a transaction. In other words, the request management unit 320 may generate, based on information for specifying a payment destination, information being usable as a bitcoin address of a payment destination.

Furthermore, the request management unit 320 may compare a payment amount indicated by payment information with a balance of a virtual currency of a proxy managed by the virtual currency management unit 310. When the payment amount is more than the balance of the proxy, the proxy is not able to execute a proxy procedure requested from a payment source. Therefore, when the payment amount is more than the balance of the proxy, the request management unit 320 may execute predetermined error processing (a notification to the terminal device 32, or the like).

The transaction management unit 340 manages generation of a transaction, and information related to generation of a transaction. The approval information management unit 341 manages secret information required for generation of approval information. Secret information in the present example embodiment includes a signing key associated with an account of a proxy. Moreover, approval information in the present example embodiment includes an electronic signature generated by use of a signing key.

Transactions generated in the transaction management unit 340 can be classified into three kinds of transactions. Hereinafter, for convenience of description, these transactions are also referred to as a “proxy-deposit transaction”, a “payment receipt transaction”, and a “payback transaction”. Moreover, a transaction used as a balance in a payment receipt transaction and a payback transaction and generated by the terminal device 32 of a payment source is also referred to as a “payment transaction”.

The proxy-deposit transaction generation unit 342 generates a proxy-deposit transaction. A proxy-deposit transaction is equivalent to one example of a “first transaction” in the first and second example embodiments. In other words, a proxy-deposit transaction functions as a deposit of a payment receipt transaction and a payback transaction described later.

A proxy-deposit transaction includes an account of a proxy, an account of a payment destination, payment destination information, and approval information of the proxy. An account of a proxy is managed by the virtual currency management unit 310. An account of a payment destination and payment destination information are managed by the request management unit 320. Approval information of a proxy is managed by the approval information management unit 341. Therefore, the proxy-deposit transaction generation unit 342 can generates a proxy-deposit transaction by use of these pieces of information managed by the virtual currency management unit 310, the request management unit 320, and the approval information management unit 341.

The acquisition unit 346 acquires, as an evidence of receipt of money, payment destination identification information transmitted from a payment destination. For example, the acquisition unit 346 receives, from the terminal device 33, a notification indicating that a payment destination has received money. Alternatively, the acquisition unit 346 may accept a similar notification not from a payment destination but from a financial institution or a credit card company. When receiving such a notification, the acquisition unit 346 may transmit a transmission request of payment destination identification information to the terminal device 33, and receive, from the terminal device 33, the payment destination identification information as a response to the transmission request. When acquiring payment destination identification information, the acquisition unit 346 supplies the payment destination identification information to the payment receipt transaction generation unit 343. Payment destination identification information is information associated with payment destination identification. Payment destination identification information may be, for example, an electronic signature generated by use of a signing key generated by a payment destination, or may be other information. Payment destination identification information is information for guaranteeing validity of a transaction including destination identification information in a destination, and is information equivalent to approval information associated with an account.

Furthermore, when acquiring payment destination identification information, the acquisition unit 346 may transmit a transmission request of approval information of a payment source to the terminal device 32 of a payment source, and acquire the approval information of the payment source.

The acquisition unit 346 may manage receipt of money by a payment destination. For example, the acquisition unit 346 may record, as a trading history, receipt of money by a payment destination. The acquisition unit 346 may further include a function of issuing a certificate for certifying that a payment destination has received money. A certificate referred to herein has an effect of a receipt or an equivalent thereof. A certificate is typically electronic data which are electronically transmitted and received, but may be printed on predetermined paper and then mailed to a payment source.

The payment receipt transaction generation unit 343 generates a payment receipt transaction. A payment receipt transaction is equivalent to one example of a “second transaction” and a “fourth transaction” in the first and second example embodiments. The payment receipt transaction generation unit 343 generates, based on the payment destination identification information supplied from the acquisition unit 346, a transaction (second transaction) using a proxy-deposit transaction as a balance, and a transaction (fourth transaction) using a payment transaction as a balance. In the present example embodiment, a second transaction and a fourth transaction are collectively called a payment receipt transaction. A balance referred to herein is equivalent to an unspent transaction output (UTXO) in bitcoin.

A payment receipt transaction includes a transaction including an account of a proxy, approval information of a proxy, and payment destination identification information, and a transaction including an account of a proxy, approval information of a proxy, and approval information of a payment source. Payment destination identification information is approval information for approving payment destination information included in a destination of a proxy-deposit transaction. The payment receipt transaction generation unit 343 may convert payment destination identification information into a form being utilizable as approval information that can be included in a transaction.

An account of a proxy and approval information of the proxy is included in a proxy-deposit transaction. Payment destination identification information is transmitted from the terminal device 33, and acquired by the acquisition unit 346. The payment receipt transaction generation unit 343 can generate a second transaction by use of a proxy-deposit transaction, and payment destination identification information transmitted from the terminal device 33.

Furthermore, approval information of a payment source is transmitted from the terminal device 32 after acquisition of payment destination identification information. Thus, the payment receipt transaction generation unit 343 can generate a fourth transaction by use of an account of a proxy and approval information of the proxy used for generation of the second transaction, and approval information of a payment source transmitted from the terminal device 32.

In this way, the proxy-deposit transaction generation unit 342 generates a transaction requiring approval information of a proxy, in such a way that a payment source and a payment destination are not able to utilize a proxy-deposit transaction and a payment transaction without an approval of a proxy.

Note that the payment receipt transaction generation unit 343 is assumed to generate two transactions as payment receipt transactions, but may generate one transaction combining the two transactions. In other words, the payment receipt transaction generation unit 343 has only to be a transaction which returns, to the payment proxy device 31, as a balance, a proxy-deposit transaction generated by the proxy-deposit transaction generation unit 342 as a deposit, and enables the payment proxy device 31 to utilize a balance of a payment transaction generated by the terminal device 32.

The payback transaction generation unit 344 generates a payback transaction. A payback transaction is equivalent to one example of a “fifth transaction” and a “sixth transaction” in the second example embodiment. The payback transaction generation unit 344 generates, as payback transactions, a transaction using a proxy-deposit transaction as a balance (i.e., UTXO), and a transaction using a payment transaction as a balance.

A payback transaction includes a transaction including an account of a proxy, approval information of a proxy, and approval information of a payment source, and a transaction including an account of a payment source, approval information of a proxy, and approval information of a payment source. An account of a proxy, an account of a payment source, and approval information of a proxy are included in a proxy-deposit transaction. Approval information of a payment source is transmitted from the terminal device 32. The payback transaction generation unit 344 can generate a payback transaction by use of an account of a proxy, an account of a payment source, approval information of a proxy, and approval information transmitted from the terminal device 32.

Note that the payback transaction generation unit 344 is assumed to generate two transactions as payback transactions, but may generate one transaction combining the two transactions. In other words, the payback transaction generation unit 344 has only to be a transaction which returns, to the payment proxy device 31, as a balance, a proxy-deposit transaction generated by the proxy-deposit transaction generation unit 342 as a deposit, and pays back, to the terminal device 32, a balance of a payment transaction generated by the terminal device 32.

The information confirmation unit 345 confirms receipt of money by a payment destination. In the present example embodiment, the information confirmation unit 345 performs the confirmation by referring to a proxy-deposit transaction and a payment transaction in the virtual currency system 34, and then confirming that the acquisition unit 346 receives payment destination identification information. More specifically, after a proxy-deposit transaction is recorded in the virtual currency system 34, and a payment transaction is recorded in the virtual currency system 34, the information confirmation unit 345 determines whether the acquisition unit 346 acquires payment destination identification information by a predetermined payment time limit. A payment time limit referred to herein is determined, for example, with reference to a timing at which a request is made from a payment source. A payment time limit may differ depending on a payment amount, or may be settable by any one of a payment source, a payment destination, and a proxy.

The information confirmation unit 345 recognizes that a payment destination has received money, with a fact that the acquisition unit 346 receives payment destination identification information by a payment time limit. The payback transaction generation unit 344 generates a payback transaction, based on a determination result by the information confirmation unit 345. Specifically, the payback transaction generation unit 344 generates a payback transaction when the acquisition unit 346 does not acquire payment destination identification information by a payment time limit.

Note that the information confirmation unit 345 may be configured in such a way as to notify a proxy that money is paid first, after a proxy-deposit transaction and a payment transaction are generated. This enables the proxy to confirm payment of money by a payment source. Moreover, in order to pay back to a payment source by generating a payback transaction when a payment destination does not receive money by a payment time limit, the information confirmation unit 345 may notify the terminal device 32 that the payment destination does not receive the money by the payment time limit. Then, the information confirmation unit 345 supplies the payback transaction generation unit 344 with approval information of a payment source received as a response to the notification.

In the present example embodiment, the proxy-deposit transaction generation unit 342 is equivalent to one example of the first generation unit 110 in the first and second example embodiments. Moreover, the payment receipt transaction generation unit 343 is equivalent to one example of the second generation unit 130 in the first and second example embodiments. The payback transaction generation unit 344 is equivalent to one example of the third generation unit 140 in the second example embodiment. The information confirmation unit 345 is equivalent to one example of the confirmation unit 150 in the second example embodiment. The acquisition unit 346 is equivalent to one example of the acquisition unit 120 in the first and second example embodiments.

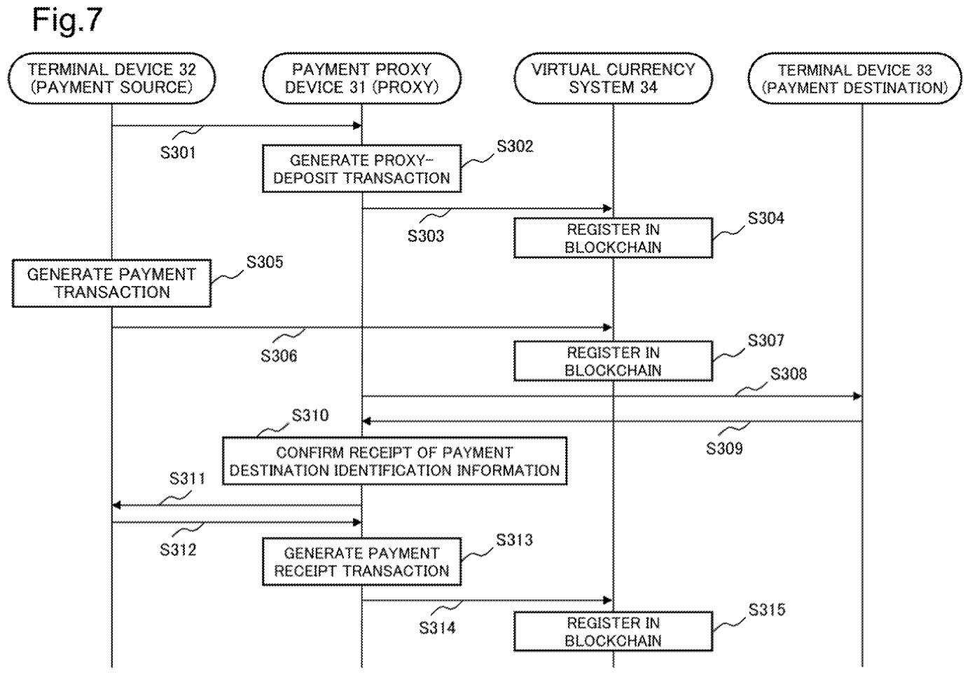

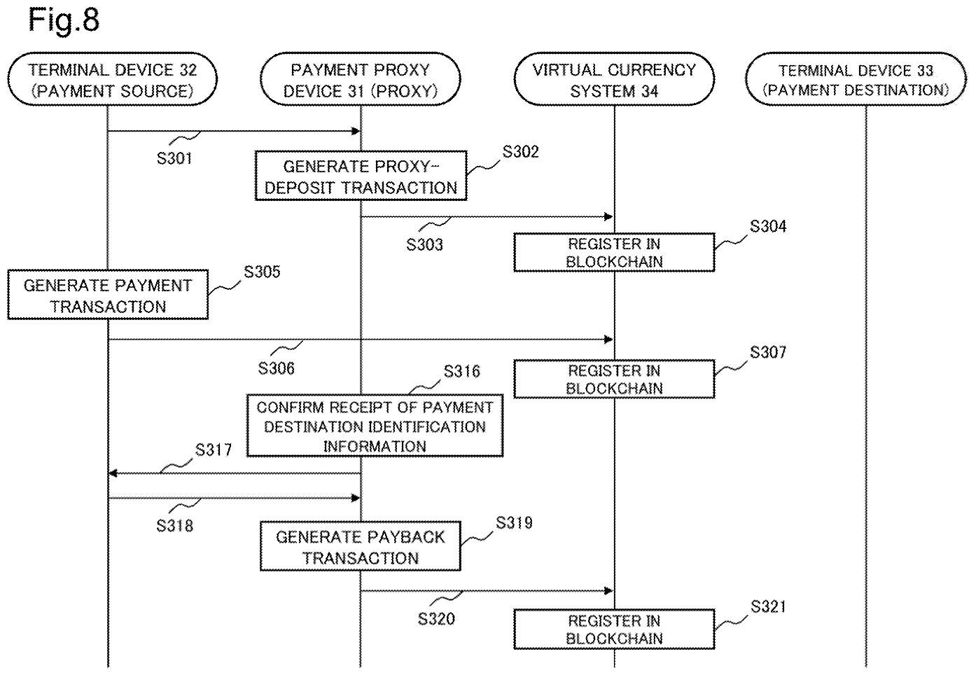

FIGS. 7 and 8 are sequence charts each illustrating an operation during trading in the payment proxy system 30. FIG. 7 illustrates an operation when a payment destination receives money by a payment time limit. On the other hand, FIG. 8 illustrates an operation when a payment destination does not receive money by a payment time limit. Note that, in FIG. 8, the same reference sign as that in FIG. 7 is given to a step in which processing similar to that in FIG. 7 is executed.

In step S301, the terminal device 32 transmits a request to the payment proxy device 31. The request involves payment information, a bitcoin address of a payment source, and information for specifying a payment destination. The terminal device 32 executes step S301, based on an operation of the payment source. The payment proxy device 31 accepts the request in the request management unit 320.

When receiving a request from the terminal device 32, the payment proxy device 31 executes step S302. In step S302, the transaction management unit 340 generates a proxy-deposit transaction, based on the request. In step S303, the transaction management unit 340 transmits the generated proxy-deposit transaction to the virtual currency system 34.

When receiving a proxy-deposit transaction from the payment proxy device 31, the virtual currency system 34 executes step S304. In step S304, the virtual currency system 34 registers the proxy-deposit transaction in a blockchain. Note that a proxy-deposit transaction, a payment transaction, a payment receipt transaction, and a payback transaction are registered in a blockchain in a way similar to other general transactions in bitcoin, i.e., by use of a well-known technique.

After transmitting a request to the payment proxy device 31, the terminal device 32 executes step S305. In step S305, the terminal device 32 generates a payment transaction. In this instance, the terminal device 32 generates the payment transaction by use of an account of a proxy provided from the payment proxy device 31 in advance or as a response to the request. Note that the terminal device 32 may execute step S305 after confirming that a proxy-deposit transaction is registered in the virtual currency system 34. In step S306, the terminal device 32 transmits the generated payment transaction to the virtual currency system 34.

When receiving a payment transaction from the terminal device 32, the virtual currency system 34 executes step S307. In step S307, the virtual currency system 34 registers the payment transaction in a blockchain.

When a proxy-deposit transaction and a payment transaction are registered in a blockchain, a proxy performs a payment procedure of money to a payment destination by a payment time limit. The proxy may pay money via the payment proxy system 30, but may pay money without intervention of the payment proxy system 30 (e.g., by transferring cash). Alternatively, the proxy may pay money to a proxy by use of a virtual currency other than bitcoin. In either case, the payment proxy device 31 notifies the terminal device 33 in step S308 that payment of money is executed.

When accepting the notification in step S308 and receiving money, the terminal device 33 executes step S309. In step S309, the terminal device 33 transmits payment destination identification information to the payment proxy device 31 as an evidence of receipt of the money.

In step S310, the transaction management unit 340 confirms whether the proxy-deposit transaction registered in step S304 and the payment transaction registered in step S307 are registered in a blockchain, and further confirms receipt of payment destination identification information. In the present example, payment destination identification information is transmitted from the terminal device 33 in step S309, and therefore the information confirmation unit 345 confirms that the acquisition unit 346 acquires the payment destination identification information.

When confirming that the acquisition unit 346 of the payment proxy device 31 has acquired payment destination identification information, the transaction management unit 340 executes step S311. In step S311, the transaction management unit 340 transmits, to the terminal device 32, a transmission request of approval information of a payment source for utilizing a payment transaction, with the payment destination identification information as an evidence of a fact that money is paid to a payment destination. In this instance, the payment proxy device 31 may transmit, in association with the transmission request, information representing that payment destination identification information is received.

When accepting the transmission request in step S311, the terminal device 32 transmits approval information of a payment source to the payment proxy device 31 in step S312. When receiving approval information of a payment source from the terminal device 32, the payment proxy device 31 executes step S313 and S314.

In step S313, the transaction management unit 340 generates a payment receipt transaction. Specifically, the payment receipt transaction generation unit 343 generates a transaction using, as a balance (UTXO), the proxy-deposit transaction registered in a blockchain in step S304, and a transaction using, as a balance (UTXO), the payment transaction registered in a blockchain in step S307.

Then, in step S314, the transaction management unit 340 transmits the payment receipt transaction generated in step S313 to the virtual currency system 34.

When receiving a payment receipt transaction from the payment proxy device 31, the virtual currency system 34 executes step S315. In step S315, the virtual currency system 34 registers the payment receipt transaction in a blockchain. Consequently, the payment receipt transaction becomes able to be utilized by a payment destination.

Next, in the example of FIG. 8, steps S301 to S307 are executed as in the example of FIG. 7. On the other hand, in this example, it is assumed that a payment destination has not received money by a payment time limit.

After step S307, the payment proxy device 31 executes step S316. In step S316, the transaction management unit 340 confirms whether the proxy-deposit transaction registered in step S304 and the payment transaction registered in step S307 are registered in a blockchain, and further confirms receipt of payment destination identification information. As described above, when a proxy-deposit transaction and a payment transaction are registered in a blockchain, a proxy performs a payment procedure of money to a payment destination by a payment time limit, but when a payment source does not receive money, a payment procedure is not completed, and therefore, the acquisition unit 346 is not able to receive payment destination identification information. The information confirmation unit 345 confirms whether payment destination identification information is received from the terminal device 33 by a payment time limit. Herein, since a case where money is not received by a payment time limit is assumed, the information confirmation unit 345 confirms that payment destination identification information is not received.

When money is not received by a payment time limit, the transaction management unit 340 executes step S317. In step S317, the transaction management unit 340 notifies the terminal device 32 that money is not received. In response to the notification, the terminal device 32 transmits approval information of a payment source to the payment proxy device 31 in step S318.

When receiving approval information of a payment source from the terminal device 32, the payment proxy device 31 executes steps S319 and S320. In step S319, the transaction management unit 340 generates a payback transaction. Specifically, the payback transaction generation unit 344 generates a transaction using, as a balance (UTXO), the proxy-deposit transaction registered in a blockchain in step S304, and a transaction using, as a balance (UTXO), a payment transaction registered in a blockchain in step S307. A destination of each of the transactions is an account of a generation source of the transaction used as a balance. Then, in step S320, the transaction management unit 340 transmits, to the virtual currency system 34, the payment transaction generated in step S319.

When receiving a payback transaction from the payment proxy device 31, the virtual currency system 34 executes step S321. In step S321, the virtual currency system 34 registers the payback transaction in a blockchain. Consequently, out of the payback transactions, a transaction using a proxy-deposit transaction as a balance becomes able to be utilized by a proxy, and a transaction using a payment transaction as a balance becomes able to be utilized by a payment source. In other words, when money is not received by a payment destination, a virtual currency for an amount paid in advance as a deposit is paid back to a proxy, and a virtual currency for an amount paid in advance is paid back to a payment source.

As described above, the payment proxy system 30 according to the present example embodiment can achieve payment proxy of a virtual currency in a decentralized virtual currency system, in a way similar to the payment proxy device 10 according to the first example embodiment and the payment proxy device 20 according to the second example embodiment. Particularly, the payment proxy system 30 enables payment proxy with bitcoin and in a virtual currency system using the bitcoin. A transaction in a bitcoin can designate a plurality of bitcoin addresses by use of a multi-signature (also referred to as “multisig”).

### Modification Examples

For example, following modifications can be applied to the first to third example embodiments described above. These modification examples can be appropriately combined as required.

(1) At trading of bitcoin, the terminal device 33 may transmit, to the terminal device 32, trading identification information for identifying trading. In this case, the terminal device 32 includes the trading identification information in a request, in addition to a bitcoin address of a payment source, payment information, and payment destination information. Trading identification information is, for example, an ID differing from trading to trading. The terminal device 32 transmits the request including the trading identification information to the payment proxy device 31.

In the payment proxy device 31, the request management unit 320 manages trading identification information. For example, prior to generation of a proxy-deposit transaction, the request management unit 320 can determine validity of trading, based on trading identification information. Specifically, the request management unit 320 inquires of the terminal device 33 about trading identification information, and determines whether trading identification information transmitted from the terminal device 32 coincides with trading identification information transmitted from the terminal device 33. When these pieces of trading identification information coincide with each other, the transaction management unit 340 generates a proxy-deposit transaction. The transaction management unit 340 may include the trading identification information in the proxy-deposit transaction.

A correspondence (i.e., a combination) between a payment destination and a payment source can be made more explicit by using such trading identification information. This can facilitate subsequent generation, registration, and confirmation of a payment receipt transaction or a payback transaction.

(2) The virtual currency management unit 310 may manage a balance of a cash currency in an account of a proxy opened in a financial institution such as a bank, in addition to a virtual currency owned by the payment proxy device 31. The virtual currency management unit 310 may manage, for example, a number of an account of a proxy, and a balance of a cash currency of the proxy. The virtual currency management unit 310 records, in a predetermined recording medium, the number of the account of the proxy, and the balance of the cash currency of the proxy, and reads the number and the balance as required. Note that the virtual currency management unit 310 may acquire a balance of a cash currency of a proxy from a system of a financial institution, without storing the balance in the payment proxy device 31. Then, the proxy-deposit transaction generation unit 342 may generate a proxy-deposit transaction by use of a balance of a virtual currency of a proxy and a balance of a cash currency owned by the proxy.

Consequently, the payment proxy device 31 can generate a proxy-deposit transaction when a proxy has an amount of a virtual currency or a cash currency for which the proxy performs payment proxy, and therefore, the payment proxy device 31 can perform payment proxy even when the payment proxy device 31 does not convert, into a virtual currency, a cash currency in an account registered in the virtual currency system 34.

(3) A specific hardware configuration of the device (the payment proxy devices 10, 20, and 31) according to the present disclosure include many variations, and is not limited to a specific configuration. For example, the device according to the present disclosure may be achieved by use of software, and may be configured in such a way as to share various kinds of processing by use of a plurality of pieces of hardware.

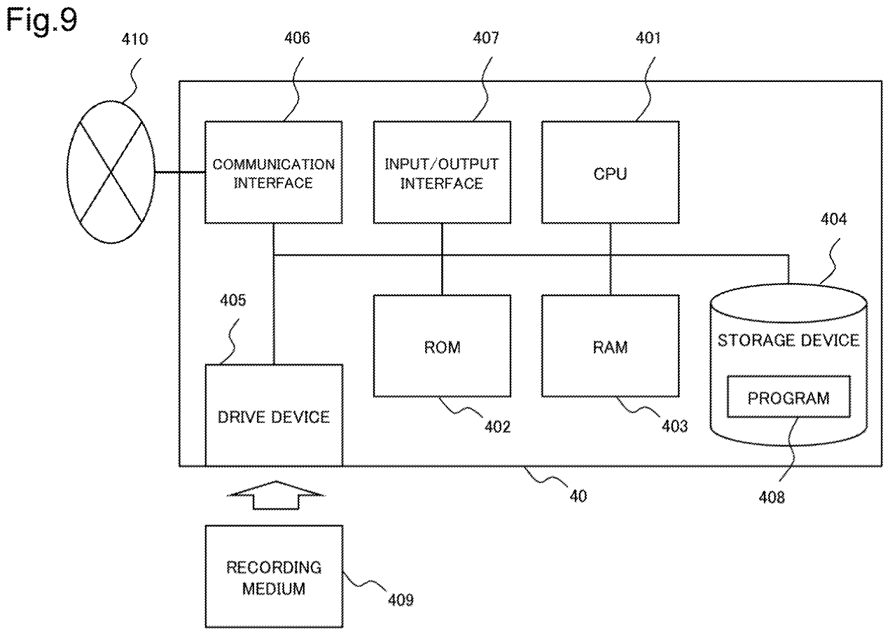

FIG. 9 is a block diagram illustrating one example of a hardware configuration of a computer device 40 which achieves the device according to the present disclosure. The computer device 40 is configured by including a central processing unit (CPU) 401, a read only memory (ROM) 402, a random access memory (RAM) 403, a storage device 404, a drive device 405, a communication interface 406, and an input/output interface 407.

The CPU 401 executes a program 408 by use of the RAM 403. The communication interface 406 exchanges data with an external device via a network 410. The input/output interface 407 exchanges data with a peripheral device (an input device, a display device, or the like). The communication interface 406 and the input/output interface 407 can function as components for acquiring and outputting data.

Note that the program 408 may be stored in the ROM 402. Moreover, the program 408 may be recorded in a recording medium 409 such as a memory card, and read by the drive device 405, or may be transmitted from an external device via the network 410.

The device according to the present disclosure can be achieved by the configuration (or a part thereof) illustrated in FIG. 9. For example, in a case of the payment proxy device 10 or 20, the first generation unit 110, the acquisition unit 120, the second generation unit 130, the third generation unit 140, and the confirmation unit 150 correspond to the CPU 401, the ROM 402, and the RAM 403.

Note that a component of the device according to the present disclosure may be configured by a single circuitry (processor or the like), or may be configured by a combination of a plurality of circuitries. A circuitry referred to herein may be dedicated or general-purpose. For example, the device according to the present disclosure may be achieved by a dedicated processor in one part, and achieved by a general-purpose processor in another part.

The configuration described as a single device in the example embodiments described above may be distributed and provided in a plurality of devices. For example, the payment proxy device 10, 20, or 31 may be achieved by cooperation of a plurality of computer devices by use of a cloud computing technique or the like.

The present invention has been described above with the example embodiments and modification examples described above as exemplary examples. However, the present invention is not limited to the example embodiments and modification examples. The present invention can include, within the scope of the present invention, example embodiments to which various modifications and applications that can be understood by a so-called person skilled in the art are applied. Moreover, the present invention can include example embodiments in which matters described in the present description are appropriately combined or replaced as required. For example, a matter described by use of a specific example embodiment is also applicable to another example embodiment within a consistent scope.

### REFERENCE SIGNS LIST

10 Payment proxy device
20 Payment proxy device
110 First generation unit
120 Acquisition unit
130 Second generation unit
140 Third generation unit
150 Confirmation unit
30 Payment proxy system
31 Payment proxy device
32 Terminal device
33 Terminal device
34 Virtual currency system
40 Computer device

1. A payment proxy device of a virtual currency, comprising:
a memory storing instructions; and
one or more processors configured to execute the instructions to:
generate a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency;
acquire payment destination identification information transmitted by a payment destination as an evidence of receipt of money and intended for identifying the payment destination; and
generate a second transaction using the first transaction as a balance, and a fourth transaction using, as a balance, a third transaction generated by the payment source, wherein
the one or more processors are further configured to execute the instructions to
generate the second transaction including, as approval information of the payment destination, the payment destination identification information acquired from the payment destination represented by the payment destination information included in the destinations of the first transaction in order to use the first transaction as a balance, and
including the approval information of the proxy, and
second destination information including the account of the proxy as a destination, and
in order to use, as a balance, the third transaction including third destination information which includes, as destinations, the account of the proxy and the account of the payment source, and the approval information of the payment source,
generate the fourth transaction including
the approval information of the payment source received from the payment source after acquisition of the payment destination identification information,
the approval information of the proxy, and
fourth destination information including the account of the proxy as a destination.

2. The payment proxy device according to claim 1, further comprising
the one or more processors are further configured to execute the instructions to,
based on the approval information of the payment source received from the payment source,
generate, by use of the first transaction as a balance, a fifth transaction including fifth destination information which includes the account of the proxy as a destination, the approval information of the proxy, and the approval information of the payment source, and
generate, by use of the third transaction as a balance, a sixth transaction including sixth destination information which includes the account of the payment source as a destination, the approval information of the proxy, and the approval information of the payment source.

3. The payment proxy device according to claim 2, further comprising
the one or more processors are further configured to execute the instructions to confirm receipt of money by the payment destination, wherein
the second transaction and the fourth transaction are generated when the receipt of the money is confirmed, and
the fifth transaction and the sixth transaction are generated when the receipt of the money is not confirmed.

4. The payment proxy device according to claim 1, wherein
the one or more processors are configured to execute the instructions to generate the first transaction by use of a balance of a virtual currency of the proxy and a balance of a cash currency owned by the proxy.

5. The payment proxy device according to claim 1, wherein
the one or more processors are configured to execute the instructions to acquire, from the payment source and the payment destination, pieces of trading identification information for identifying trading of a virtual currency, and generate the first transaction when pieces of the acquired trading identification information coincide with each other.

6. The payment proxy device according to claim 1, wherein
the virtual currency is bitcoin, and
the one or more processors are configured to execute the instructions to generate the second transaction by use of the first transaction as an unspent transaction output (UTXO), and generate the fourth transaction by use of the third transaction as an UTXO.

7. A payment proxy method of a virtual currency, comprising:
generating a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency;
acquiring payment destination identification information transmitted by a payment destination as an evidence of receipt of money and intended for identifying the payment destination;
generating a second transaction by use of the first transaction as a balance, the second transaction including, as approval information of the payment destination, the payment destination identification information acquired from the payment destination represented by the payment destination information included in the destinations of the first transaction, and including second destination information which includes the approval information of the proxy and the account of the proxy as a destination; and
by use of, as a balance, a third transaction generated by the payment source, and including third destination information which includes, as destinations, the account of the proxy and the account of the payment source, and the approval information of the payment source, generating a fourth transaction including the approval information of the payment source received from the payment source after acquisition of the payment destination identification information, the approval information of the proxy, and fourth destination information including the account of the proxy as a destination.

8. The payment proxy method of a virtual currency according to claim 7, further comprising
based on the approval information of the payment source received from the payment source,
generating, by use of the first transaction as a balance, a fifth transaction including fifth destination information which includes the account of the proxy as a destination, the approval information of the proxy, and the approval information of the payment source, and
generating, by use of the third transaction as a balance, a sixth transaction including sixth destination information which includes the account of the payment source as a destination, the approval information of the proxy, and the approval information of the payment source.

9. A computer-readable non-transitory recording medium recording a program which causes a computer to execute:
processing of generating a first transaction by use of a balance of a proxy in response to a request from a payment source, the first transaction including first destination information which includes, as destinations, an account of the proxy, an account of the payment source, and payment destination information representing a payment destination, and approval information of the proxy, and being a transaction indicating trading of a virtual currency;
processing of acquiring payment destination identification information transmitted by a payment destination as an evidence of receipt of money and intended for identifying the payment destination; and
processing of generating a second transaction using the first transaction as a balance, and a fourth transaction using, as a balance, a third transaction generated by the payment source, wherein
the second transaction
includes, as approval information of the payment destination, the payment destination identification information acquired from the payment destination represented by the payment destination information included in the destinations of the first transaction in order to use the first transaction as a balance, and
includes
the approval information of the proxy, and
second destination information including the account of the proxy as a destination, and
the fourth transaction includes,
in order to use, as a balance, the third transaction including third destination information which includes, as destinations, the account of the proxy and the account of the payment source, and the approval information of the payment source,
the approval information of the payment source received from the payment source after acquisition of the payment destination identification information,
the approval information of the proxy, and
fourth destination information including the account of the proxy as a destination.

10. The recording medium according to claim 9, wherein
the program further causes a computer to execute,
based on the approval information of the payment source received from the payment source,
processing of generating, by use of the first transaction as a balance, a fifth transaction including fifth destination information which includes the account of the proxy as a destination, the approval information of the proxy, and the approval information of the payment source, and
generating, by use of the third transaction as a balance, a sixth transaction including sixth destination information which includes the account of the payment source as a destination, the approval information of the proxy, and the approval information of the payment source.
